(19) United States
(12) Patent Application Publication
(10) Pub. No.: US 2023/0407890 A1
(43) Pub. Date: Dec. 21, 2023

(54) ACTUATOR

(71) Applicant: Microtecnica S.r.l., Turin (IT)

(72) Inventors: Michele RESTUCCIA, Milano (IT); Dario MOLINELLI, Carnate (IT); Franco MAINO, Brugherio (IT)

(21) Appl. No.: 18/332,266

(22) Filed: Jun. 9, 2023

(30) Foreign Application Priority Data
Jun. 17, 2022 (EP) 22179763.2

(51) Int. Cl. F15B 15/20; B64C 13/40

(52) U.S. Cl. CPC F15B 15/20; B64C 13/40

(57) ABSTRACT

An actuator includes a housing and a piston including an axis. The piston and housing are configured to move relative to each other along the axis. The housing comprises at least one chamber for holding a fluid, the piston being positioned partially within the chamber. A seal configured to isolate the fluid in the chamber is positioned between the piston and the housing. The seal includes a seal body and an energiser. At least one pressure relief conduit is located between the energiser and the chamber. The pressure relief conduit configured to relieve fluid pressure built up in a region between the energiser and the chamber.

### CROSS REFERENCE TO RELATED APPLICATION

This application claims priority to European Patent Application No. 22179763.2 filed Jun. 17, 2022, the entire contents of which is incorporated herein by reference.

### TECHNICAL FIELD

The invention relates to actuators and aircraft controls, more particularly to dynamic piston seals for hydraulic actuators. The invention would apply equally to pneumatic actuators, and so the actuators described could be referred to as fluidic actuators.

### BACKGROUND

Hydraulic actuators are known in the art. Referring to FIGS. 1, 2 and 3, hydraulic actuators may comprise a fixed piston 12 and a movable body or housing 8 surrounding the fixed piston 12. The fixed piston 12 includes a shaft 15 and a piston head 3. Hydraulic fluid chambers 2 are provided on either side of the piston head 3 (e.g., a forward chamber 2B and a reverse chamber 2A).

In order to operate the actuator, the actuator housing 8 is moved in a linear direction along the fixed piston 12 (e.g., in a forward or rearward/reverse direction relative to a longitudinal axis 9 of the piston). To initiate this movement, a control or pilot spool 4 is moved from a resting or null position (as shown in FIG. 1), to an active or moving position (as shown in FIG. 2) wherein a fluid (e.g., a high pressure hydraulic fluid) is provided to one of the chambers 2B via a fluid supply 5, whilst the other of the chambers 2A is connected to a fluid return 6 (a fluid exhaust). The fluid supply 5 is at a higher pressure than the fluid return 6 and the corresponding higher pressure and lower pressure is communicated to the corresponding chambers 2B, 2A as chamber pressures P1, P2. The resulting pressure difference between the chambers creates a driving force to move the housing 8 in a forward or reverse direction, thereby creating a housing displacement, D, relative to an initial or median position. This movement continues until the pressure between the chambers is equalised (i.e., until P1 is equal to P2, generally referred to as the null pressure P0). As the housing 8 moves the relative position of the control spool 4 to the housing 8 changes such that it returns to a null position (i.e., a new resting position as shown in FIG. 3), wherein the supply of fluid is arrested.

Seals (e.g., ring seals) are provided between the piston 12 and the housing 8 (e.g., between the shaft 15 and the housing 8) at the periphery of the chambers 2 to isolate pressurised fluid within the actuator (e.g., within the chambers 2A, 2B). Seals may additionally be provided between the chambers to prevent leakage between the chambers which may lead to slower response times. To ensure efficient operation and prevent leakage, it is vital that these seals firmly engage with the piston 12 and/or housing 8. Undesirably, however, such firm engagement (i.e. relatively high friction engagement) leads to increased friction which acts against the driving force provided by the pressure difference resulting in a systematic error between a set position and an actual position attained by the actuator housing. The firm engagement between seal and the piston 12 or housing 8 can also cause the seal to deform, extrude and slip or slide within a seal groove which causes the behaviour of the actuator to be unpredictable and unreliable (e.g. the actuator can operate with a sudden and inconsistent lurching movement).

Conventional attempts to improve on actuator performance have focused on maintaining the seal in a fixed position. For example, GB759375A discloses a hydraulic actuator wherein the peripheral surface of the piston is vented to normal atmospheric pressure or a pressure which is below that of the fluid in chamber. As the fluid pressure within the chamber greatly exceeds atmospheric pressure, the sealing rings remain permanently compressed against the inner side walls of their respective grooves. Undesirably, this solution creates a constant stress on the seals with can lead to increased wear and extrusion of the seal. It also increases the firmness of the seal engagement which can lead to a greater residual error, and may lead to increased leakage due to a constant and relatively high pressure differential across the seal. The requirement to vent part of the apparatus to atmosphere also requires significant modification of the actuator, and limits the use of the apparatus (e.g., it cannot be readily used in high pressure environments)

Thus, there remains a need for improved fluidic actuators.

### SUMMARY

In an aspect, an actuator is provided. The actuator comprises a housing and a piston. The housing comprises at least one chamber for holding a fluid and the piston comprises an axis and is positioned partially within the chamber. A seal is positioned between the piston and the housing and configured to isolate a fluid in the chamber. The piston and the housing are configured to move relative to each other along the axis. One of the piston or the housing comprises a seal groove in which the seal is positioned. The seal comprises a seal body (e.g., a resilient seal body) and an energiser. The energiser is positioned (and, e.g., configured) to bias the seal body against the other of the piston or the housing (e.g., against a sealing surface). The actuator comprises at least one pressure relief conduit located between the energiser and the chamber which is configured to relieve fluid pressure built up in the region between the energiser and the chamber.

The pressure relief conduit allows chamber pressure (e.g., the pressure of a fluid within the chamber) to be communicated to the energiser and/or seal body. The chamber pressure can thusly provide an energising pressure (e.g., an additional energising pressure) to the seal body to improve the quality of a seal between the piston and the housing (e.g., a seal formed between the seal body and an opposing sealing surface). This is particularly relevant when the chamber pressure is increased to a relatively high pressure because the likelihood of seal failure (e.g., leakage) is increased at such pressures. The pressure relief conduit also provides an avenue for fluid (e.g., relatively high pressure, or otherwise trapped or encapsulated fluid) around the seal body (e.g., within or adjacent to the energiser) to return to the chamber. In this way unwanted energising pressure (e.g., additional or excess energising pressure) can be relieved from the seal so as not to create undesirable resistance to movement (e.g., due to excess friction between the seal body and an opposing sealing surface). This is particularly relevant when the chamber pressure is reduced (e.g., equalised) below an initial relatively higher pressure, as the seal is less likely to fail under these conditions, and resistance to movement (e.g., the relative movement between the piston and the housing) becomes of greater relevance for high precision operations.

In embodiments, the piston and the housing may be configured to move relative to each other under the action of a or the fluid (e.g. a hydraulic or pneumatic fluid).

The actuator may further comprise a cavity defined between the seal groove and the seal body (and/or the energiser). The pressure relief conduit may be configured to fluidly communicate the chamber with the cavity. The cavity may be continuous (e.g., annular). The cavity may be discontinuous (e.g., comprise a plurality of discrete portions or cavities). The cavity may be configured to hold a fluid communicated from the chamber during use.

The provision of such a cavity allows for a volume of fluid to be retained below the seal body and for improved communication of the chamber pressure to the seal body (e.g., better communication between chamber pressure and energising pressure). The cavity also provides a pressure sink (e.g., a high or low pressure sink provided by a volume of relatively high or low pressure fluid) which can facilitate the dampening of changes in the energising pressure and allow for smoother operation.

The pressure relief conduit may be configured to limit a rate of fluid transfer between the energiser or cavity and the chamber to a given rate of fluid transfer (e.g. a set rate or determined/predetermined rate of fluid transfer).

By limiting or controlling the rate of fluid transfer between the energiser or cavity and the fluid chamber, the rate at which the seal quality and resistance to movement changes can be controlled. The behaviour of the actuator can thusly be controlled to provide more rapid or, conversely, more dampened responses. In this way actuator performance can be tailored to specific applications.

Alternatively, no cavity may be present and the pressure relief conduit may communicate directly with the seal body (e.g., the pressure relief conduit may extend between the chamber and a surface of the seal body such as a radially outer or radially inner surface of the seal body).

The piston may comprise a piston head. The piston head may define a movable boundary of the chamber.

The pressure of fluid acting on the piston head (e.g., on an axial surface area of the piston head) may provide the driving force for the relative movement between the piston and housing.

The seal may be configured to isolate a relatively high pressure fluid within the chamber on a first side of the seal from a relatively low pressure fluid on a second side of the seal (e.g., a side located exterior to the chamber).

The actuator may further comprise a control spool. The control spool may be configured to selectively communicate a fluid supply with the chamber, such that a pressure within the chamber increases (e.g. a pressure of a fluid within the chamber). The control spool may be configured to selectively communicate a fluid exhaust with the chamber. The fluid exhaust may have a pressure which is lower than a pressure of the chamber (e.g. a pressure of a fluid within the chamber, or a normal working pressure of the chamber). The fluid exhaust may have a pressure (e.g. a fluid pressure) which is lower than a pressure of the fluid supply.

The pressure relief conduit may be formed at least partly in a radially extending surface (e.g., an annular and/or axially facing surface) of the seal groove.

It is believed that forming (e.g., engraving, etching, machining) the pressure relief conduit in a radially extending surface of the seal groove allows for precise control of the conduit, and improves the ease of manufacture, particularly in relatively small and precise actuators and/or in retrofitting operations. More sophisticated surface designs can also be realised in this way.

The pressure relief conduit may extend at least partially in an axial direction through the housing (i.e., a through-hole) between the chamber and the energiser.

Axially extending conduits present with a relatively small or no contact area between the seal body and the conduit. Stated differently, a path of the conduit is not at least partially defined by the seal body (e.g., a resilient seal body). Thus, the seal body or, more particularly, the potential deformation of the seal body has no bearing on the performance of the conduit, and the actuator may provide more reliable (e.g., predictable) performance.

The pressure relief conduit may be formed as a cut or slit through a wall of the seal groove, thereby extending axially between the chamber and the seal body for at least an entire radial distance of the seal body.

In another aspect a wing flap system comprising the actuator is provided.

In another aspect an aircraft comprising the actuator is provided.

In another aspect a method of operating the actuator is provided. The method includes supplying a fluid to the chamber, the fluid having a fluid pressure which is higher or lower than a pressure (e.g., a pressure of another fluid) on a side of the seal which is exterior to the chamber, and moving the piston and the housing relative to each other under the action of the fluid pressure (e.g., the pressure difference between the pressure of the fluid within the chamber and a pressure of a fluid exterior to the chamber).

In another aspect method of method of modifying an actuator is provided. The method comprises providing an actuator, the actuator comprising a housing and a piston, the housing comprising at least one chamber for holding a fluid and the piston comprising an axis and being positioned partially within the chamber, a seal being positioned between the piston and the housing and configured to isolate a fluid in the chamber, the piston and the housing being configured to move relative to each other along the axis, one of the piston or the housing comprising a seal groove in which the seal is positioned, the seal comprising a seal body (e.g., a resilient seal body) and an energiser, the energiser being positioned to bias the seal body against the other of the piston or the housing (e.g., against a sealing surface). The method further comprises forming a pressure relief conduit between the energiser or seal body and the chamber.

Modifying an actuator or retrofitting the pressure relief conduit into an actuator (e.g., an existing actuator) allows for the performance of existing systems to be improved (e.g., during scheduled maintenance). This method of manufacturing allows existing systems to be reused and reduces the cost, downtime (e.g. aircraft downtime) and environmental impact of implementing the actuators.

In embodiments, the forming may comprise etching, machining or milling the pressure relief conduit feature into one of the piston and the housing.

### BRIEF DESCRIPTION OF THE DRAWINGS

The following descriptions should not be considered limiting in any way. With reference to the accompanying drawings, like elements are numbered alike:

FIG. 1 shows a schematic of a hydraulic actuator (e.g., in accordance with conventional arrangements and embodiments of the invention) in a resting position;

FIG. 2 shows a schematic of a hydraulic actuator (e.g. the actuator of FIG. 1) in an active position;

FIG. 3 shows a schematic of a hydraulic actuator (e.g. the actuator of FIG. 1 or 2) in a displaced position;

FIG. 4A shows a dynamic seal for a hydraulic actuator wherein a chamber is in a pressurised state;

FIG. 4B shows the dynamic seal of FIG. 4A wherein the chamber is in an equalised state;

FIGS. 5A and 5B show residual errors in housing displacement and control spool position when employing the seal of FIG. 4A;

FIG. 6 shows a dynamic seal in accordance with embodiments;

FIG. 7 shows another dynamic seal in accordance with embodiments;

FIG. 8 shows the performance characteristics of a dynamic seal in accordance with embodiments;

FIG. 9 shows the performance characteristics of another dynamic seal in accordance with embodiments; and

FIG. 10 shows an aircraft in accordance with embodiments.

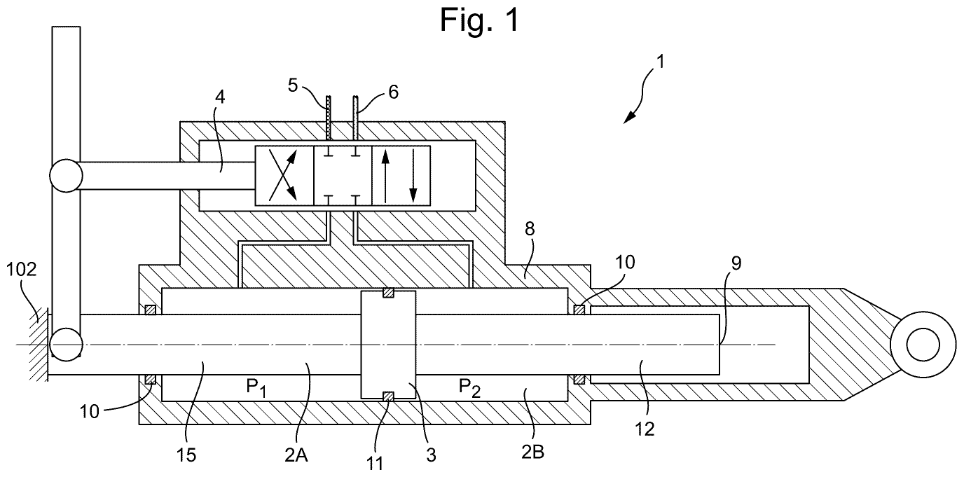

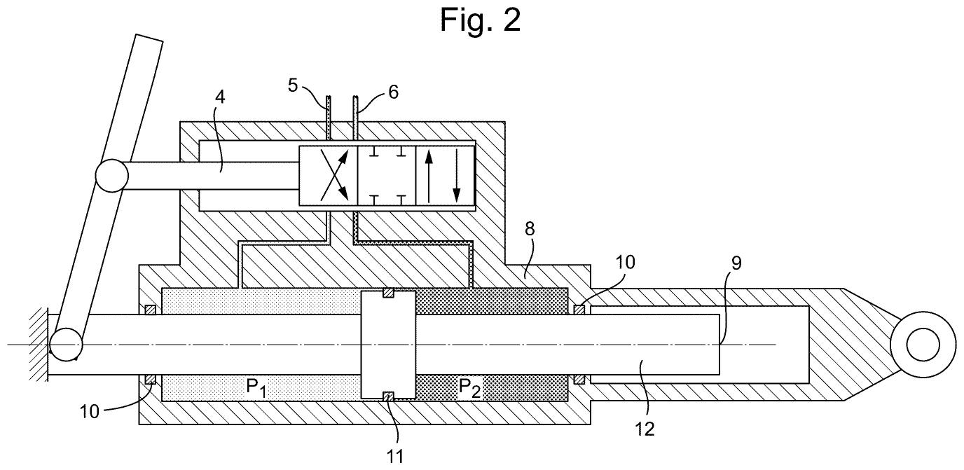

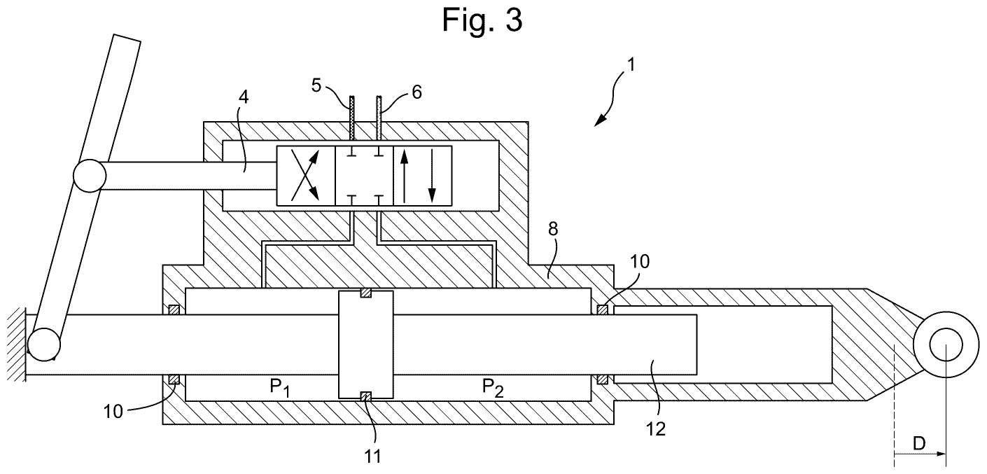

### DETAILED DESCRIPTION

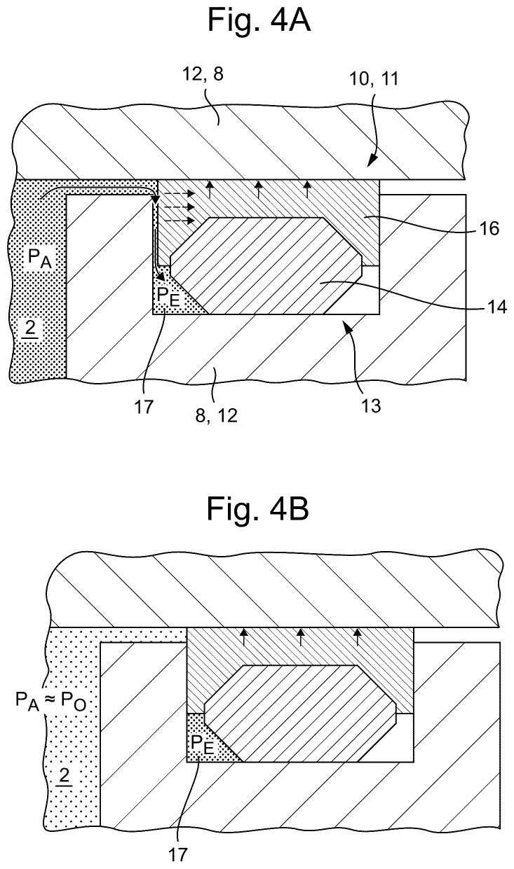

Initial attempts to improve on the residual error have focussed on the use of dynamic seals 10, 11 including a seal body 16 and seal energiser 14 provided in a seal groove 13 surrounding the piston 12 (see FIGS. 4A and 4B). Each of the seal body 16, seal energiser 14 and the seal groove 13 may be annular in shape. However, other shapes and configurations are also envisaged (e.g., a cuboid piston may be used in conjunction with four separate linear dynamic seals, or may comprise dynamic seals on some surfaces but not on others). Similarly, the seal body 16 may comprise a continuous (e.g., annular) shape and the seal energiser 14 may be discontinuous (e.g., comprise a plurality of energising elements which are interconnected or discrete from one another). The seal body 16 may be sized to fit a width of the groove 13 (e.g., to have a seal width which is be equal to the width of the groove 13). The seal body 16 may comprise a resilient material. Selecting appropriate sizing and materials for the seal body 16 can help prevent the seal from moving freely within the groove 13, thereby preventing slippage of the piston and positional inaccuracies. The seal energiser 14 applies pressure on the seal body 16 in a radial direction, so as to improve the sealing quality between the piston 12 and the housing 8 (e.g., by increasing friction between the seal body 16 and an opposing sealing surface). The seal energiser 14 may comprise a width which is less than a width of the seal groove 13. A cavity 17 (free space or vacancy) may be provided between the seal groove 13, the seal body 16 and the seal energiser 14. The cavity 17 may span the width of the seal groove 13 (e.g., connecting forward and rear/reverse sides of the seal groove). Alternatively, the cavity 17 may be confined to a side (e.g., forward or reverse side) of the seal groove 13. Corresponding cavities 17 may be provided on both sides (e.g., forward or reverse sides) of the energiser 14.

The seal groove 13 may be provided in the housing 8 with the seal body 16 positioned radially inwardly of the seal energiser 14 such that it is biased against the piston 12. Alternatively, the seal groove 13 may be provided in the piston 12 itself with the seal body 16 positioned radially outwardly of the seal energiser 14 such that it is biased against the housing 8.

With reference to FIG. 4A, during operation of the hydraulic actuator, and when a relatively high pressure fluid is communicated with one of the chambers 2 (e.g., the forward chamber 2B is in a pressurised state), the correspondingly high chamber pressure P1, P2 (generally referred to as PA), is communicated to the seal body 16 (e.g., via an annular axial channel defined between the piston 12 and housing 8). The communication of this relatively high chamber pressure PA to the seal body 16 causes the seal body 16 to deform (e.g., periodically compress) and high pressure fluid to enter the seal groove 13 housing the energiser 14. Advantageously, this causes the chamber pressure PA to be communicated to the seal groove 13 (e.g. to a cavity 17 defined between the seal groove 13, the seal body 16 and the seal energiser 14) and creates an additional energising pressure, PE, on the seal body 16. The provision of this energising pressure PE occurs in concert with the presence of relatively high chamber pressure PA. Thus, the firmness of the seal 10, 11 engagement (i.e. the friction between the seal 10, 11 and an opposing sealing surface) is modulated with the chamber pressure PA and the driving force of the actuator 1. The increased friction is not detrimental when there is a high pressure, as the high pressure creates proportionally high driving force. This reduces the positional error and allows for much smoother operation since the magnitude of the resistance to movement increases and decreases relative to the driving force for movement.

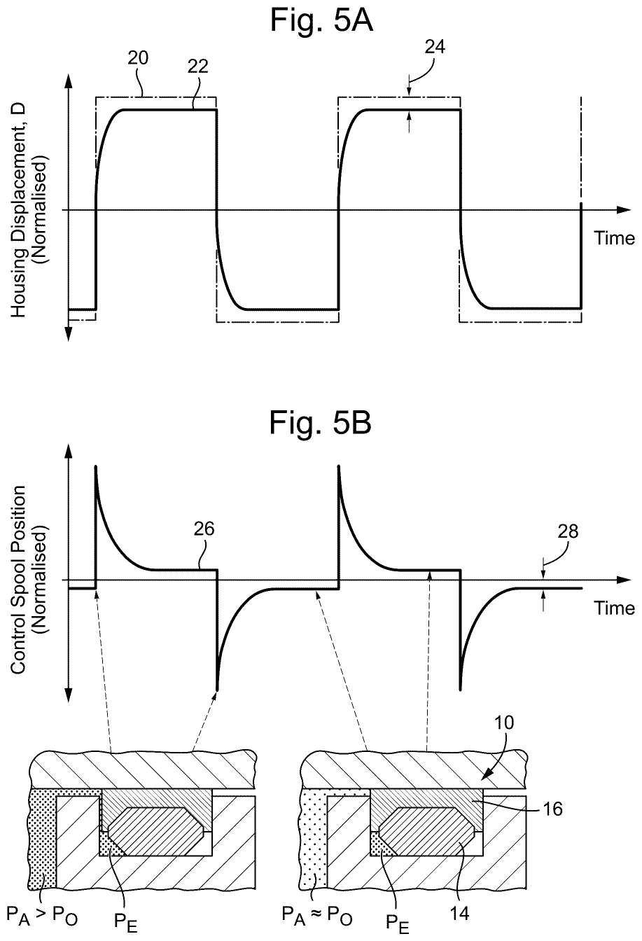

It has been found that when the pressure between chambers equalises, such that chamber pressure PA is reduced towards the null pressure P0, the seal body 16 recovers from deformation. As the seal body 16 is no longer deformed, the chamber pressure PA is no longer communicated to the seal groove 13 or cavity 17 meaning that higher pressure fluid is effectively trapped behind the seal body 16. The energising pressure PE is therefore greater than the chamber pressure PA (see FIG. 4B), which means that the seal 10, 11 engagement remains firmer than necessary. As a result, and with reference to FIG. 5A, excess friction causes a small residual error 24 to remain.

FIG. 5A shows the positional behaviour of a hydraulic actuator with dynamic seals 10, 11 as it is repeatedly moved between a forward position and a rear position. Here it can be seen that the output or actual position 22 of the actuator closely follows the input or set point position 20 of the actuator (e.g., as set by a controller or operator). However, though a step change is provided at the input 20, the change in output position 22 instead slows slightly as it approaches the set point (exaggerated for illustrative purposes). The output position also fails to reach the set point with a residual error 24 present in both the forward and reverse step changes. It is believed that these residual errors are the product of the aforementioned trapped fluid occurring in the corresponding forward and rear seals causing excess friction between the piston 12 and housing 8.

FIG. 5B shows the corresponding position of the control spool 26 (normalised relative to the actuator pressure) when the actuator is repeatedly moved between a forward position and a rear position as in FIG. 5A. Here it can be seen that, following its initial step change, the control spool 4 does not fully return its null position such that it presents an offset 28 from the null position as a result of the residual error of the housing position. This offset 28 can cause further problems when the actuator 1 is next commanded to move. For example, if the output position of the actuator has to be finely tuned (e.g., in high precision aircraft operations), an initial offset in the opposite direction to travel (e.g., forward instead of reverse) can create a response delay. Similarly, the response can be unexpectedly fast if an offset is present is the same direction of travel. This can create undesirable variation in the performance of the actuator 1.

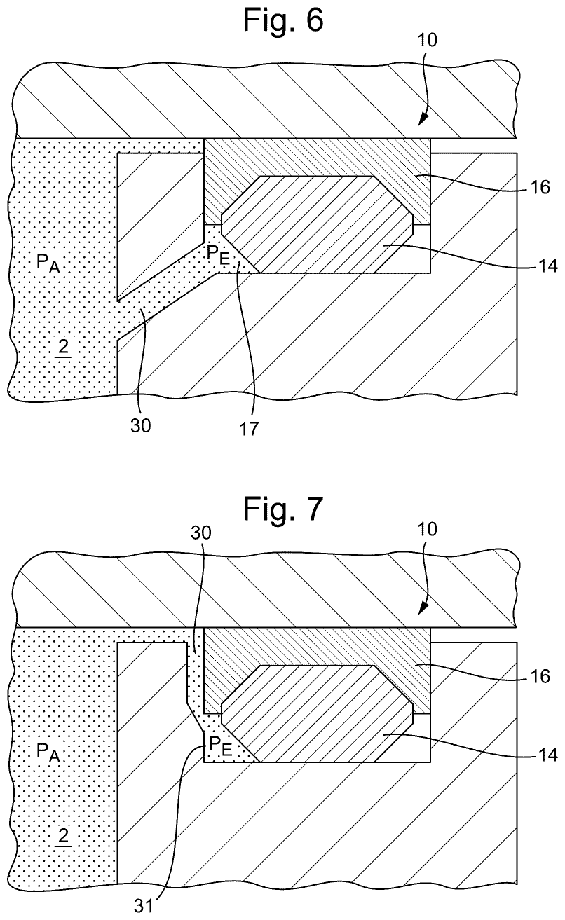

As shown in FIGS. 6 and 7, in order to further improve on actuator 1 performance, and to better modulate seal engagement with the piston 12 and/or housing 8, one or more pressure relief features (or pressure communication features) may be provided within the seal groove 13. The pressure relief features may comprise one or more pressure relief conduits 30.

The pressure relief features serve to better communicate the chamber pressure PA with the energising pressure PE. In so doing, energising pressure PE does not become “trapped” within the seal groove (e.g., within a cavity 17 defined between the seal groove 13, the seal body 16 and the seal energiser 14) and the residual error caused by unintentional energising of the seal is eliminated.

The pressure relief conduit 30 may comprise a channel or passage extending in a generally axial direction (e.g., parallel to the piston axis 9). The channel or passage direction may also comprise a radial component (see FIG. 6).

Alternatively, the pressure relief conduit may be formed at least partly on a surface of the seal groove 13. For example, the pressure relief conduit 30 may be formed (e.g., drilled, etched or engraved) in a radially-extending side face 31 (forward or rear annular face) of the seal groove (see FIG. 7 which shows a cross section intersecting a radially extending pressure relief conduit 30). Similarly, the pressure relief conduit may be formed as a cut or slit through a wall (e.g., an entire axial width of a wall) of the seal groove, thereby extending axially between the chamber and the seal body for at least an entire radial distance of the seal body (not shown).

The pressure relief conduit 30 may be provided at the point of manufacture of the actuator. Alternatively, the pressure relief conduit 30 may be formed by modifying an existing actuator 1. For example, the pressure relief conduit 30 may be introduced (e.g. retrofitted) during a maintenance operation of an actuator 1, so as to improve the actuator's performance. The conduit 30 may link with the chamber 2 via an annular axial channel (e.g., a channel defined between the piston 12 and housing 8, see FIG. 7).

It has been found that placing the pressure relief conduit 30 in the seal groove, as opposed to placing a pressure relief feature in the seal body 16 itself, leads to greatly enhanced performance. This is because modifying the seal body 16 can give rise to unpredictable results and reduce the integrity of the seal, leading to increase wear and maintenance requirements of the actuator. Further, as the seal body may comprise resilient material, any pressure relief features formed therein may deform and act unpredictably. It is also more difficult to tune the response behaviour of the pressure relief feature when present in the seal body, as the behaviour of the seal body may change with time.

Placing the pressure relief feature in the seal groove 13 of the piston 12 or housing also allows for enhanced tuning of the performance and behaviour of the actuator. For example, because the piston and/or housing is typically manufactured from an inelastic material (e.g., a metallic material), it is possible to form highly defined (micrometre or nanometre scale) features therein. Thus, the communication between the seal groove 13 or cavity 17 and the chamber 2 can be metered and tuned so as to control the speed at which the chamber pressure PA and energising pressure PE equalise.

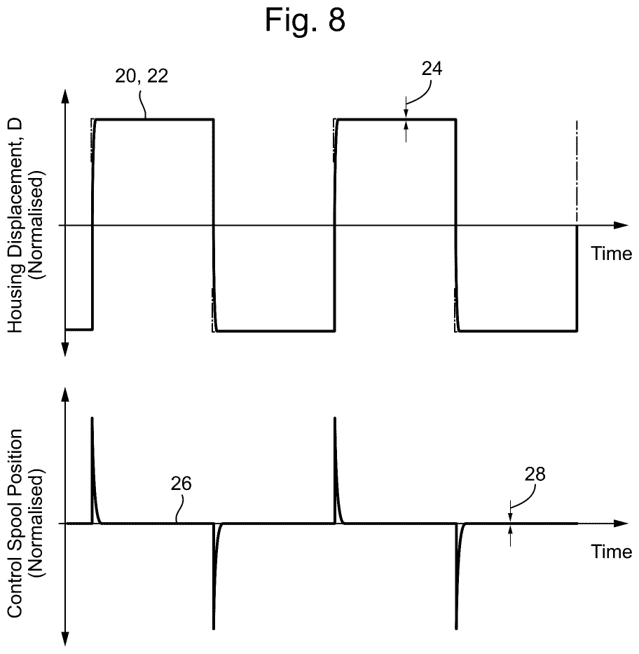

With reference to FIGS. 6 and 8, when a relatively large channel is employed as a pressure relief conduit 30 (as illustrated in FIG. 6), the chamber pressure PA and energising pressure PE are freely communicated with each other. In this case the actuator will exhibit a rapid (near instant) response time as the energising pressure PE is quickly reduced with chamber pressure such that the seal firmness is synchronised with the pressure difference between forwards and reverse chambers 2A, 2B. Thus, the driving force for moving the housing is synchronised with the resistance to movement such that a low resistance is present when the chamber pressure PA is reduced towards the null pressure P0. Accordingly, the housing can continue to move without significant resistance to the set point and, consequently, no residual error 24 is present between the input or set point position 20 and the output or actual position 22 of the housing. Similarly, the control spool 4 is allowed to move to its null position such that no offset 28 is present and the undesirable variation in the performance of the actuator can be abated.

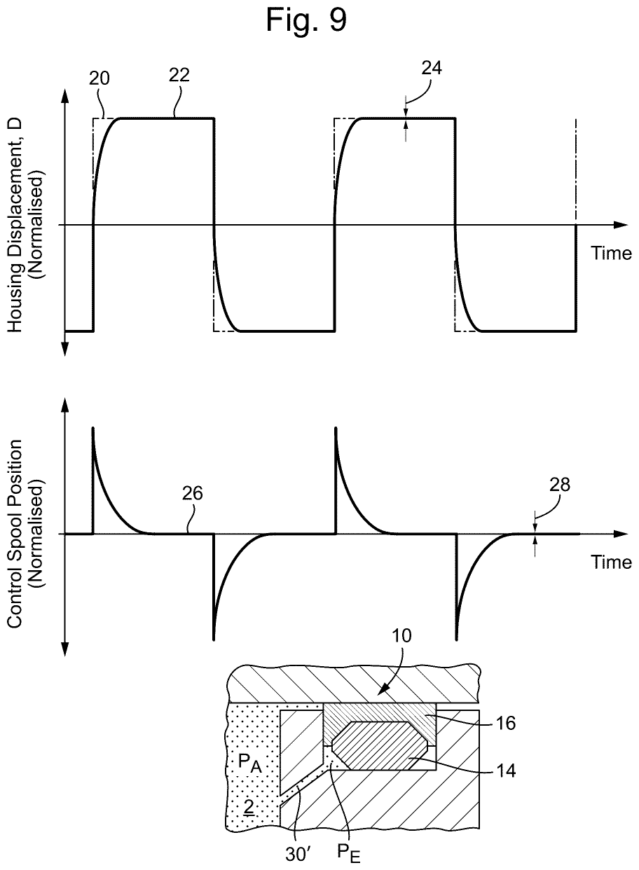

Alternatively, as illustrated in FIG. 9, when a relatively smaller channel is employed as a pressure relief conduit 30 (here denoted as 30′), the flow between the seal groove 13 or cavity 17 and chamber 2 can be constricted. Stated differently, the pressure relief conduit 30 can be configured to limit the rate of fluid transfer between the energiser 14 and the chamber 2 to a set or given rate of fluid transfer. In this way the rate of equalisation between chamber pressure PA and energising pressure PE can be reduced to a relatively slower rate. Here, again, the housing 8 can continue to move to the set point such that no residual error 24 is present, but it may take longer to do so. In this way the actuator 1 can be configured to create a dampened response (e.g. inertial dampening, or “soft closing”) which may be preferential in certain applications where relatively rapid and high inertia movements are detrimental (e.g., heavy machinery). Again, the control spool 4 is allowed to move to its null position (albeit over a longer period of time) such that no offset 28 is present and the undesirable variation in the performance of the actuator can be abated.

It is contemplated that many other techniques may be used to tune the response of the actuator. The size and frequency of the pressure relief conduits 30 can be modified to tailor response behaviour of movable housing. Similarly, shape of the pressure relief conduit 30 can be modified (e.g., v-shaped groove, conical passage) so as to modify the response behaviour. If a channel is used as pressure relief conduit 30, the channel may be a straight channel or a curved channel. The channel may have a constant cross-section or a variable cross-section. For example, the channel may constrict to a narrow orifice or nozzle.

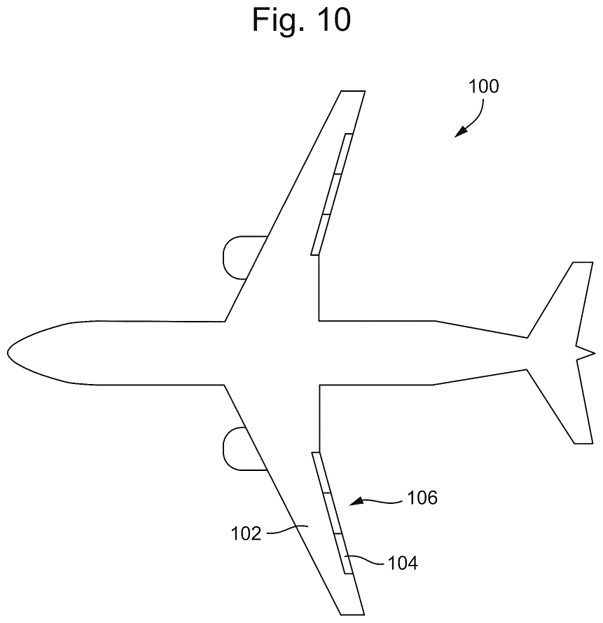

Used herein the term “fixed” is intended to define an element which is secured to a first (e.g., major) body (e.g., a wing 102 on an aircraft 100, as shown in FIG. 10). Similarly, the term “movable” is intended to define an element which is secured to a second (e.g., minor) body which is movable relative to the first body (e.g., a flap 104). Embodiments include an aircraft 100 or wing flap system 106 comprising the described actuators. Whilst exemplary embodiments have been described in relation to a fixed piston and movable housing, it should be noted that the disclosed seal configurations may equally be applied to the reverse configuration of a fixed housing and movable piston. Although described as fixed, it should also be appreciated that the fixed element (piston or housing) may be pivotally attached to a fixed structure (e.g., an aircraft bulkhead—not shown).

Further, one or more pressure relief conduits 30 may be provided only on one side (e.g., forward or rear) of the seal groove 13, or may be provided on both sides of the seal groove 13 (e.g., to corresponding cavities 17 on either side of the energiser 14). For example, when employing the described seal configuration between chambers 2 (e.g., circumscribing the piston head 3), it may be beneficial to communicate both chambers 2A, 2B to respective sides of the seal groove 13 such that the energising pressure PE may be provided from either of the chambers 2A, 2B (e.g., from which ever of the chambers is in communication with the relatively high pressure supply 5).

The teachings herein may also be applied to other fluidic actuators known in the art, e.g., pneumatic actuators.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims

1. An actuator comprising:
a housing comprising at least one chamber for holding a fluid;
a piston comprising an axis, the piston positioned partially within the chamber; and
a seal positioned between the piston and the housing, the seal configured to isolate a fluid in the chamber;
wherein the piston and the housing are configured to move relative to each other along the axis;
wherein one of the piston or the housing comprises a seal groove in which the seal is positioned, the seal comprising a seal body and an energiser, the energiser biasing the seal body against the other of the piston or the housing;
wherein the actuator comprises at least one pressure relief conduit located between the energiser and the chamber, and configured to relieve fluid pressure built up in the region between the energiser and the chamber.

2. An actuator according to claim 1, wherein the piston and housing are configured to move relative to each other under the action of the fluid.

3. An actuator according to claim 1, further comprising: a cavity defined between the seal groove, the seal body and the energiser, wherein the pressure relief conduit is configured to fluidly communicate the chamber with the cavity.

4. An actuator according to claim 3, wherein the pressure relief conduit is configured to limit a rate of fluid transfer between the cavity and the chamber to a given rate of fluid transfer.

5. An actuator according to claim 1, wherein the piston comprises a piston head which defines a movable boundary of the chamber.

6. An actuator according to claim 1, wherein the seal is configured to isolate a relatively high pressure fluid within the chamber on a first side of the seal from a relatively low pressure fluid on a second side of the seal.

7. An actuator according to claim 1, further comprising a control spool, wherein the control spool is configured to selectively communicate a fluid supply with the chamber, such that a pressure within the chamber increases.

8. An actuator according to claim 7, wherein the control spool is configured to selectively communicate a fluid exhaust with the chamber, the fluid exhaust having a pressure which is lower than a pressure of the fluid supply.

9. An actuator according to claim 1, wherein the pressure relief conduit is formed in a radially extending surface of the seal groove.

10. An actuator according to claim 1, wherein the pressure relief conduit extends at least partially in an axial direction through the housing between the chamber and the energiser.

11. A wing flap system comprising:
an actuator as claimed in claim 1.

12. An aircraft comprising:
an actuator as claimed in claim 1.

13. A method of operating an actuator according to claim 1, the method comprising:
supplying a fluid to the chamber, the fluid having a fluid pressure which is higher than a pressure on a side of the seal which is exterior to the chamber; and
moving the piston and the housing relative to each other under the action of the fluid pressure.

14. A method of modifying an actuator comprising:
providing an actuator, the actuator comprising:
a housing comprising a chamber, the chamber for holding a fluid;
a piston comprising an axis, the piston positioned partially within the chamber;
a seal positioned between the piston and the housing, the seal configured to isolate a fluid in the chamber;
wherein the piston and the housing are configured to move relative to each other along the axis along the axis, and wherein one of the piston or the housing comprises a seal groove in which the seal is positioned, the seal comprising a seal body and an energiser, the energiser biasing the seal body against the other of the piston or the housing; and
forming a pressure relief conduit between the energiser and the chamber.

15. A method according to claim 14, wherein the forming comprises etching, machining or milling the pressure relief conduit feature into one of the piston and the housing.
